(19) United States
(12) Patent Application Publication
(10) Pub. No.: US 2002/0173858 A1
(43) Pub. Date: Nov. 21, 2002

(54) Method for achieving adaptive thermal management of DSL modems

(76) Inventor: Ian J. Sherlock, Dallas, TX (US)

Correspondence Address: TEXAS INSTRUMENTS INCORPORATED, P O BOX 655474, M/S 3999, DALLAS, TX, 75265

(21) Appl. No.: 09/900,394

(22) Filed: Jul. 6, 2001

Related U.S. Application Data
(60) Provisional application No. 60/279,834, filed on Mar. 29, 2001.

(51) Int. Cl. G05B 15/00

(52) U.S. Cl. 700/1

(57) ABSTRACT

A system and method for measuring die temperature of chips within an ATU-C modem and reporting the results to a central management entity such that, in the event of a thermal overload condition, an adaptive algorithm can change modem operation so a data connection can be maintained. The system and method may include integrating temperature detection sensors on each semiconductor device in an ATU-C modem chipset and the power supply module. The temperature sensors then report the die temperatures of each component in the chipset to the central management entity that can interact with the individual modem datapumps to manage power dissipation within the modem system.

### BACKGROUND OF THE INVENTION

1. Field of the Invention

This invention relates generally to DSL modems and more particularly to a method for adaptive thermal management of DSL modems.

2. Description of the Prior Art

There is currently no way to know the die operating temperature of chips within an ATU-C DSL modem chipset. In the event of a thermal overload condition, ATU-C modems fail in an unpredictable manner causing end users to lose their data connection.

In the competitive central office ADSL environment, equipment providers desire to support the largest possible number of ATU-C ADSL modems in each linecard in order to enable service providers to support the largest number of end users with the minimum dedicated equipment space in the central office. It follows that semiconductor vendors are constantly increasing the number of modems supported by ATU-C modem chipsets and searching for more aggressive chipset packaging techniques to reduce the PCB space required for each ATU-C modem. A consequence of this aggressive integration is that, although the power consumed by each ADSL ATU-C modem is decreasing from generation to generation, the reduction in footprint per modem is tending to increase the power density at the PCB level. The increased power density poses many thermal challenges for the modem design engineer. In general, ATU-C modems have to be designed to meet various NEBS specifications for system level thermal performance. NEBS specifications define ambient air temperature conditions for various classes of equipment.

There are two problems associated with the thermal design process. First, a given PCB design can be stressed in a test laboratory to the limits of the appropriate NEBS specification; but it is difficult to determine the exact chipset die temperatures at the NEBS specification limit; and so it is difficult to know what “safety margin” has been built into a given design or which component is thermally critical. Second, when a modem is deployed in the field, if the operating conditions stray outside the chosen NEBS limit (i.e. an equipment fan fails, causing excessive localized temperature elevation), then modems will fail unpredictably, causing loss of service for attached customers. A consequence of the trend toward increasing ATU-C modem density is than when such a thermal violation exists, a large number of customers can be adversely impacted.

PCBs are conventionally designed to meet the NEBS specifications using thermal simulation tools. After the PCB is fabricated, temperature sensors are connected to the case of each semiconductor in a test lab to measure the operating case temperature of each device. The disadvantage of this approach is that the semiconductor die temperature has to be approximated from knowledge of the case temperature, a process prone to error. Further, the application of a large external temperature sensor to a small semiconductor package can distort the measured temperature because the thermal probe tends to conduct heat from the semiconductor package. In order to measure safety margin, the thermal stress is increased until “something goes wrong” and the margin is measured by comparing the failing temperature with the desired maximum operating temperature. This process does not provide good visibility into the thermal performance of the PCB, nor does it easily identify the thermally critical components in the design.

Conventional ATU-C modems make no provision for adaptive thermal management. The general assumption is made that the modems meet Bellcore® NEBS specifications. For systems with forced air cooling, a mechanism is usually provided for varying air flow rate via fan control as a function of gross air temperature, but no attempt is made to monitor individual die temperature. If a cooling system failure (such as a mechanical problem with a fan or HVAC system) exists, then eventually, if the problem is not addressed, the modems will overheat and fail in an unpredictable way, causing data loss for the end user. If a large number of users experience data loss, the penalties for a service provider can be serious, both from a financial and regulatory perspective (the FCC has to be informed).

U.S. Pat. No. 5,978,864, entitled Thermal Overload Detection and Prevention in an Integrated Circuit Processor, discloses a method to control die temperature. The method disclosed and claimed in the '864 patent, however, is specifically directed to a simple reduction in processor clock frequency with excessive die temperature, and does not disclose or suggest use of a more general adaptive thermal management approach to realize an analog DSL modem application.

In view of the foregoing, a need exists for a method for measuring die temperature of chips within an ATU-C modem and reporting the results to a management entity such that, in the event of a thermal overload condition, an adaptive algorithm can change modem operation so that a data connection can be maintained.

### SUMMARY OF THE INVENTION

The present invention is directed to a system and method for measuring die temperature of chips within an ATU-C modem and reporting the results to a central management entity such that, in the event of a thermal overload condition, an adaptive algorithm can change modem operation so a data connection can be maintained. The method includes integrating temperature detection sensors on each semiconductor device in an ATU-C modem chipset and the power supply module. The temperature sensors then report the die temperatures of each component in the chipset to the central management entity that can interact with the individual modem datapumps to manage power dissipation within the modem system.

According to one aspect, die temperature sensors are provided to allow precise measurement of semiconductor die temperature, eliminating the approximations associated with a measurement of case temperature.

According to another aspect, die temperature sensors are provided to allow precise measurement of semiconductor die temperature, eliminating the thermal distortion associated with an external sensor with large thermal mass.

According to yet another aspect, die temperature sensors are provided to allow precise measurement of semiconductor die temperature, allowing precise measurement of the safety margin between the actual and maximum die operating temperatures. This in turn allows the thermally critical components on a given PCB to be identified.

According to still another aspect, chip level sensing of the die temperature for each modem component is provided, allowing the modem to adaptively change service levels to manage die temperature. This means that in the event of a system thermal problem, e.g. HVAC system failure, the management system can be informed and take one on many desired actions so that data communication can be maintained without a failure.

### BRIEF DESCRIPTION OF THE DRAWINGS

Other aspects and features of the present invention and many of the attendant advantages of the present invention will be readily appreciated as the same become better understood by reference to the following detailed description when considered in connection with the accompanying drawings in which like reference numerals designate like parts throughout the figures thereof and wherein:

FIG. 1 illustrates implementation of an adaptive thermal management scheme in association with an AC5 modem chipset available from Texas Instruments Incorporated of Dallas, Tex. according to one embodiment of the present invention.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

The exact die temperature of each chip within a modem chipset is now available in a test laboratory environment so that the thermal “safety margin” of a given PCB implementation can easily be determined by operating the PCB in a thermal test chamber set to the appropriate stress conditions and recording the temperature of each die. The difference between the die temperature and the maximum operating temperature of the die (defined by the semiconductor manufacturer) provides the safety margin for each component in the PCB design; so it is easy to identify the thermally critical components. Once thermally critical components have been identified, necessary changes to PCB design, airflow, heatsinking, and the like, can be made to ensure reliable operation of the system in the field.

When a modem is deployed in the field, in the event of a failure in a fan system, CO HVAC, or some other environmental problem, die temperature detectors can flag an impending chip level thermal overload problem to an attached management entity. Instead of having the modems fail en masse or be undesirably turned off, the management entity can adaptively manage the modem configuration (e.g. by reducing modem data throughput) to control local power dissipation; so that the die temperatures remain within acceptable limits. The value of adaptive thermal management to a telecom service provider is that a data connection can be maintained (at reduced throughput) without having to shut equipment down immediately and cut end users off. A further advantage of this approach is that the temperature data can be exposed to customer management equipment allowing continuous monitoring of thermal status.

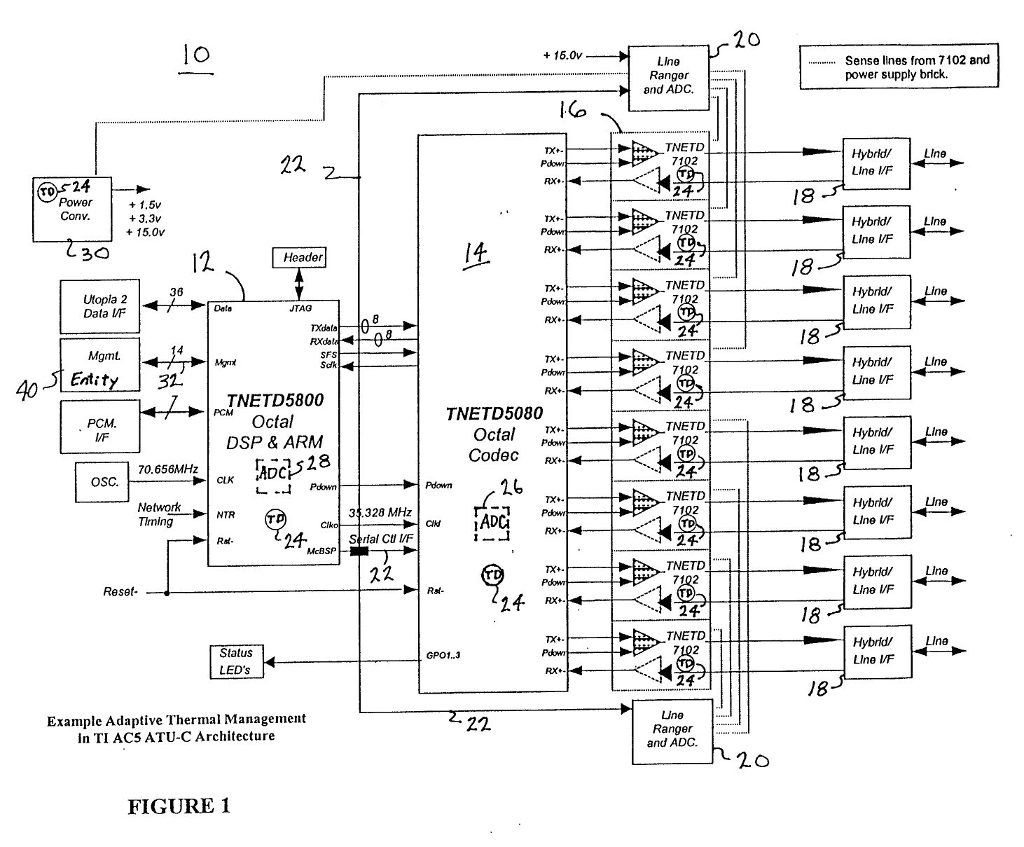

FIG. 1 is a block diagram illustrating a system architecture 10 that implements an adaptive thermal management scheme in association with an AC5™ modem chipset available from Texas Instruments Incorporated (TI) of Dallas, Tex. according to one embodiment of the present invention. The system architecture 10 can implement an adaptive thermal management scheme simply by adding an on-chip diode/thermal detector (TD) within each device in the chipset, with PCB traces to a slow, inexpensive, external multi-input analog-to-digital converter (ADC), read via GPIO from the modem datapump 12 or equivalent. Alternatively, the on-chip thermal detector (TD) could be mated with an on-chip ADC to provide a digital output that is fed to the modem datapump 12.

With continued reference to FIG. 1, the AC5 chipset can be seen to include a TNETD5800™ datapump 12 that acts as an ADSL datapump for eight independent ATU-C modems, converting a Utopia ATM cell stream into samples that are fed to a TNETD5080™ octal (eight channel) codec 14. The codec 14 supports eight analog interfaces to eight TNETD7102™ line driver receiver chips 16. In conjunction with a hybrid circuit 18, each TNETD7102™ line driver receiver chip 16 forms the copper loop interface for a single ATU-C modem. Two “Line Ranger” components 20 allow individual control of the supply voltage applied to the line driver receiver chips 16. This control allows for optimization of the ATU-C modem power consumption to match the needs of the attached copper loop.

Looking again at FIG. 1, an adaptive thermal management system according to one embodiment can include a temperature sensitive structure (TD) 24, for example a diode, on each die in the chipset as stated herein before. In the case of the TNETD7102™ line driver receiver chips 16, the TD would be connected via an additional signal pin to an ADC. System architecture 10 shows the ADC as being located in the Line Ranger 20. This arrangement leverages the natural proximity of the Line Ranger 20 the line driver receiver chips 16, as well as the existing serial connection 22 between the Line Ranger 20 and the TNETD5800™ datapump 12. This configuration allows the datapump 12 to control the supply voltage for each line driver receiver chip 16 and also read the die temperature of each line driver receiver chip 16. The TNETD5080™ octal (eight channel) codec 14 also can seen to contain a temperature sensing element (TD) 24 as well as an ADC 26 that allows the TNETD5800™ datapump 12 to read the codec 14 die temperature along with other codec 14 control parameters via the existing serial control interface 22. The TNETD5800™ datapump 12 also contains a temperature sensing element 24 as well as a small ADC 28 that allows the die temperature to be measured. An additional temperature sensing element 24 in the main power supply 30 brick heatsink is also interfaced to one of the ADC channels in the Line Ranger 20. This allows the temperature of the power supply 30 brick heatsink to be monitored. The present invention is not so limited however, and it shall be understood that a wide variety of other implementations are possible. One example includes deployment of a custom ADC that monitors all the die temperature sensors directly.

During operation, at power-up in a cold environment, the thermal detectors 24 can be used to hold each device in a non-operational “warm-up” mode until each die has reached a desired operating temperature, as stated herein before. The system 10 then boots normally and the ARM core in the TNETD5800™ datapump 12 periodically (e.g. once every second) reads the die temperatures. Temperature measurements are made available to an external management entity 40 via the TNETD5800™ datapump 12 OAM register interface 32. The measured die temperatures are compared to a table of alarm threshold die temperatures. The default alarm thresholds reflect the characteristics of the semiconductor process used to manufacture each chip. The default alarm thresholds are chosen such that operating each device below the alarm threshold will allow for normal modem operation. When a given die temperature exceeds the alarm threshold, an alarm condition is recorded. This can optionally notify the external management entity, which then has responsibility to take action, or alternatively, the modem datapump 12 can take action. The action taken will reflect the source of the alarm. Example actions are shown in Table I below.

TABLE I

| Alarm Source | Action(s) |
|---|---|
| TNETD7102 Line driver/receiver | Reduce modem throughput via re- |
| | negotiation. |
| | Gradually reduce ATU-C modem |
| | transmit power. |
| | Increase system airflow by changing |
| | fan speed. |
| | Disable modem channel. |
| | Reduce line driver supply voltage via |
| | Line Ranger. |
| TNETD5080 Codec | Increase system airflow by changing |
| | fan speed. |
| TNETD5800 ™ datapump 12 | Disable non core user applications |
| | running on the ARM or DSP |
| | subsystems. |
| | Increase system airflow by changing |
| | fan speed. |
| | Disable 1-8 modem channels. |
| | Alter core clock speed. |
| Power Supply heatsink | Any action listed above. |
| | Shut down/reduce power to user |
| | specific circuitry on the |
| | line card, e.g data interface |
| | of management processor. |

In view of the above, it can be seen the present invention presents a significant advancement in the art of thermal management associated with DSL modems. A system architecture has been described to include placement of thermal structures on each die in a CO modem chipset to allow temperature measurement of each die and reporting to a modem OAM system. Programmable thermal thresholds are supported to allow the modem OAM system to use ADSL features such as power swap, dynamic rate adaptation, forced retrain to lower speed, Line Ranger re-biasing of drivers, balancing of user applications on CPU, and the like, to adaptively manage die temperatures, and thus avoid hard thermal failures. Independent thresholds allow thermal alarms to be issued to the host before or after a modem take adaptive action.

This invention has been described in considerable detail in order to provide those skilled in the DSL modem art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. An adaptive thermal management system comprising:
a modem chipset having thermal management algorithms integrated therein;
at least one thermal detection sensor associated with at least one predetermined chip selected from the modem chipset; and
at least one analog-to-digital converter (ADC) configured to receive analog signals generated via the at least one thermal detection sensor and generate digital output signals therefrom such that the modem chipset, directed by the thermal management algorithms, can monitor the digital output signals and automatically adapt operating conditions of the modem chipset in response to the digital output signals to control operating temperatures of the at least one predetermined chip.

2. The adaptive thermal management system according to claim 1 wherein the at least one ADC is integral to the modem chipset.

3. The adaptive thermal management system according to claim 1 wherein the at least one ADC is external to the modem chipset.

4. The adaptive thermal management system according to claim 1 further comprising an external management entity having thermal management algorithms integrated therein such that the external management entity, directed by the thermal management algorithms integrated therein, can monitor the digital output signals and automatically adapt operating conditions of the modem chipset in response to the digital output signals to control operating temperatures of the at least one predetermined chip.

5. The adaptive thermal management system according to claim 1 wherein the modem chipset is an ATU-C modem chipset.

6. The adaptive thermal management system according to claim 1 wherein the modem chipset comprises:
a datapump configured to support a plurality of independent modems;
a multichannel codec configured to transmit signals to the datapump and receive signals from the datapump;
a plurality of line drivers configured to transmit signals to the codec;
a plurality of receivers configured to receive signals from the codec; and
a plurality of interface devices configured to transmit signals from the plurality of line drivers and transmit signals to the plurality of receivers to implement copper loop interfaces for each independent modem.

7. The adaptive thermal management system according to claim 6 wherein the datapump is configured to act as an ADSL datapump for a plurality of independent ATU-C modems.

8. The adaptive thermal management system according to claim 6 further comprising at least one line ranger device configured to provide individual control of a supply voltage applied to each line driver or receiver.

9. The adaptive thermal management system according to claim 1 wherein the at least one thermal detection sensor comprises a diode.

10. The adaptive thermal management system according to claim 1 wherein the modem chipset, directed by the thermal management algorithms, can monitor the digital output signals and automatically adapt operating conditions of the modem chipset in response to the digital output signals to control operating temperatures of the at least one predetermined chip by reducing modem throughput via re-negotiation.

11. The adaptive thermal management system according to claim 1 wherein the modem chipset, directed by the thermal management algorithms, can monitor the digital output signals and automatically adapt operating conditions of the modem chipset in response to the digital output signals to control operating temperatures of the at least one predetermined chip by gradually reducing ATU-C modem transmit power.

12. The adaptive thermal management system according to claim 1 wherein the modem chipset, directed by the thermal management algorithms, can monitor the digital output signals and automatically adapt operating conditions of the modem chipset in response to the digital output signals to control operating temperatures of the at least one predetermined chip by changing a fan speed to increase system airflow.

13. The adaptive thermal management system according to claim 1 wherein the modem chipset, directed by the thermal management algorithms, can monitor the digital output signals and automatically adapt operating conditions of the modem chipset in response to the digital output signals to control operating temperatures of the at least one predetermined chip by disabling at least one modem channel.

14. The adaptive thermal management system according to claim 1 wherein the modem chipset, directed by the thermal management algorithms, can monitor the digital output signals and automatically adapt operating conditions of the modem chipset in response to the digital output signals to control operating temperatures of the at least one predetermined chip by reducing line driver and receiver supply voltage via a line ranger.

15. The adaptive thermal management system according to claim 1 wherein the modem chipset, directed by the thermal management algorithms, can monitor the digital output signals and automatically adapt operating conditions of the modem chipset in response to the digital output signals to control operating temperatures of the at least one predetermined chip by disabling non-core user applications running on a modem chipset ARM subsystem or a modem chipset DSP subsystem.

16. The adaptive thermal management system according to claim 1 wherein the modem chipset, directed by the thermal management algorithms, can monitor the digital output signals and automatically adapt operating conditions of the modem chipset in response to the digital output signals to control operating temperatures of the at least one predetermined chip by altering the core clock speed.

17. The adaptive thermal management system according to claim 1 wherein the modem chipset, directed by the thermal management algorithms, can monitor the digital output signals and automatically adapt operating conditions of the modem chipset in response to the digital output signals to control operating temperatures of the at least one predetermined chip by shutting down or reducing power to user specific circuitry on a line card.

18. An adaptive thermal management system comprising:
a modem chipset having thermal management algorithms integrated therein;
thermal detection sensing means associated with at least one predetermined chip selected from the modem chipset; and
means for receiving analog signals generated via the thermal detection sensing means and for generating digital output signals therefrom such that the modem chipset, directed by the thermal management algorithms, can monitor the digital output signals and automatically adjust operating conditions of the modem chipset in response to the digital output signals to control operating temperatures associated with the modem chipset.

19. The adaptive thermal management system according to claim 18 wherein the means for receiving analog signals generated via the thermal detection sensing means and for generating digital output signals therefrom is integral to the modem chipset.

20. The adaptive thermal management system according to claim 18 wherein the means for receiving analog signals generated via the thermal detection sensing means and for generating digital output signals therefrom is external to the modem chipset.

21. The adaptive thermal management system according to claim 18 further comprising an external controlling means for controlling operating temperatures of the at least one predetermined chip, wherein the external controlling means has thermal management algorithms integrated therein such that the external controlling means, directed by the thermal management algorithms integrated therein, can monitor the digital output signals and automatically adjust operating conditions of the modem chipset in response to the digital output signals to control operating temperatures of the at least one predetermined chip.

22. The adaptive thermal management system according to claim 21 wherein the modem chipset, directed by the thermal management algorithms contained within the external controlling means, can monitor the digital output signals and automatically adapt operating conditions of the modem chipset in response to the digital output signals to control operating temperatures of the at least one predetermined chip by reducing modem throughput via re-negotiation.

23. The adaptive thermal management system according to claim 21 wherein the modem chipset, directed by the thermal management algorithms contained within the external controlling means, can monitor the digital output signals and automatically adapt operating conditions of the modem chipset in response to the digital output signals to control operating temperatures of the at least one predetermined chip by gradually reducing ATU-C modem transmit power.

24. The adaptive thermal management system according to claim 21 wherein the modem chipset, directed by the thermal management algorithms contained within the external controlling means, can monitor the digital output signals and automatically adapt operating conditions of the modem chipset in response to the digital output signals to control operating temperatures of the at least one predetermined chip by changing a fan speed to increase system airflow.

25. The adaptive thermal management system according to claim 21 wherein the modem chipset, directed by the thermal management algorithms contained within the external controlling means, can monitor the digital output signals and automatically adapt operating conditions of the modem chipset in response to the digital output signals to control operating temperatures of the at least one predetermined chip by disabling at least one modem channel.

26. The adaptive thermal management system according to claim 21 wherein the modem chipset, directed by the thermal management algorithms contained within the external controlling means, can monitor the digital output signals and automatically adapt operating conditions of the modem chipset in response to the digital output signals to control operating temperatures of the at least one predetermined chip by reducing line driver and receiver supply voltage via a line ranger.

27. The adaptive thermal management system according to claim 21 wherein the modem chipset, directed by the thermal management algorithms contained within the external controlling means, can monitor the digital output signals and automatically adapt operating conditions of the modem chipset in response to the digital output signals to control operating temperatures of the at least one predetermined chip by disabling non-core user applications running on a modem chipset ARM subsystem or a modem chipset DSP subsystem.

28. The adaptive thermal management system according to claim 21 wherein the modem chipset, directed by the thermal management algorithms contained within the external controlling means, can monitor the digital output signals and automatically adapt operating conditions of the modem chipset in response to the digital output signals to control operating temperatures of the at least one predetermined chip by altering the core clock speed.

29. The adaptive thermal management system according to claim 21 wherein the modem chipset, directed by the thermal management algorithms contained within the external controlling means, can monitor the digital output signals and automatically adapt operating conditions of the modem chipset in response to the digital output signals to control operating temperatures of the at least one predetermined chip by shutting down or reducing power to user specific circuitry on a line card.

30. The adaptive thermal management system according to claim 18 wherein the modem chipset is an ATU-C modem chipset.

31. The adaptive thermal management system according to claim 18 wherein the modem chipset comprises:
a datapump configured to support a plurality of independent modems;
a multichannel codec configured to transmit signals to the datapump and receive signals from the datapump;
a plurality of line drivers configured to transmit signals to the codec;
a plurality of receivers configured to receive signals from the codec; and
a plurality of interface devices configured to transmit signals from the plurality of line drivers and transmit signals to the receivers to implement copper loop interfaces for each independent modem.

32. The adaptive thermal management system according to claim 31 wherein the datapump is configured to act as an ADSL datapump for a plurality of independent ATU-C modems.

33. The adaptive thermal management system according to claim 31 further comprising at least one line ranger device configured to provide individual control of a supply voltage applied to each line driver/receiver.

34. A method of adaptive thermal management for DSL modems comprising the steps of:
providing a modem chipset having at least one thermal detection sensing device integrated into at least one chip die associated with the modem chipset and further having a thermal management algorithmic software and at least one ADC operational to receive analog signals generated via the at least one thermal detection sensing device and to generate digital output signals therefrom; and
monitoring the digital output signals and automatically adjusting operating conditions of the modem chipset via the thermal management algorithmic software in response to the digital output signals to control operating temperatures of the at least one chip die.

35. The method according to claim 34 wherein the operating temperatures of the at least one chip die are controlled by reducing modem throughput via re-negotiation.

36. The method according to claim 34 wherein the operating temperatures of the at least one chip die are controlled by gradually reducing modem transmit power.

37. The method according to claim 34 wherein the operating temperatures of the at least one chip die are controlled by changing a fan speed to increase system airflow.

38. The method according to claim 34 wherein the operating temperatures of the at least one chip die are controlled by disabling at least one modem channel.

39. The method according to claim 34 wherein the operating temperatures of the at least one chip die are controlled by reducing a modem chipset line driver and receiver supply voltage via a line ranger.

40. The method according to claim 34 wherein the operating temperatures of the at least one chip die are controlled by disabling non-core user applications running on a modem chipset ARM subsystem or a modem chipset DSP subsystem.

41. The method according to claim 34 wherein the operating temperatures of the at least one chip die are controlled by altering the core clock speed.

42. The method according to claim 34 wherein the operating temperatures of the at least one chip die are controlled by shutting down or reducing power to user specific circuitry on a line card associated with the modem chipset.

43. A method of adaptive thermal management for DSL modems comprising the steps of:
providing a modem chipset having at least one thermal detection sensing device integrated into at least one chip die associated with the modem chipset;
providing an external management entity having a thermal management algorithmic software integrated therein;
providing at least one ADC operational to receive analog signals generated via the at least one thermal detection sensing device and to generate digital output signals therefrom; and
monitoring the digital output signals via the external management entity and automatically adjusting operating conditions of the modem chipset via the thermal management algorithmic software in response to the digital output signals to control operating temperatures of the at least one chip die.
